(19) United States
(12) Patent Application Publication
(10) Pub. No.: US 2025/0258637 A1
(43) Pub. Date: Aug. 14, 2025

(54) CONTENT SHARING CONTROL METHOD, APPARATUS, STORAGE MEDIUM, AND TERMINAL

(71) Applicant: GUANGDONG OPPO MOBILE TELECOMMUNICATIONS CORP., LTD., Dongguan (CN)

(72) Inventor: Junwen HU, Dongguan (CN)

(73) Assignee: GUANGDONG OPPO MOBILE TELECOMMUNICATIONS CORP., LTD., Dongguan (CN)

(21) Appl. No.: 19/020,356

(22) Filed: Jan. 14, 2025

Related U.S. Application Data
(63) Continuation of application No. PCT/CN2023/102909, filed on Jun. 27, 2023.

(30) Foreign Application Priority Data
Jul. 18, 2022 (CN) 202210845059.5

(51) Int. Cl. G06F 3/14; G06F 3/04817; G06F 3/0486

(52) U.S. Cl. CPC G06F 3/1454; G06F 3/04817; G06F 3/0486

(57) ABSTRACT

A content sharing control method includes: displaying a multitask management page, wherein the multitask management page comprises at least one application window corresponding to at least one application; when a selection operation is performed on any one application window of the at least one application window corresponding to the at least one application, obtaining a first display content of a first application corresponding to a selected first application window; and sharing the first display content to a share-receiving terminal.

### CROSS REFERENCE TO RELATED APPLICATIONS

The present application is a continuation application of the international patent application PCT/CN2023/102909, filed on Jun. 27, 2023, which claims the priority of the Chinese patent application No. 202210845059.5, filed on Jul. 18, 2022, in the title of “CONTENT SHARING CONTROL METHOD, APPARATUS, STORAGE MEDIUM, AND TERMINAL”, contents of which are incorporated herein by its entireties.

### TECHNICAL FIELD

Embodiments of the present disclosure relate to the technical field of intelligent terminals, and more specifically, to a content sharing control method, an apparatus, a storage medium, and a terminal.

### BACKGROUND

As the internet and mobile terminals develop, mobile terminals are rapidly popularized. In the art, mobile terminals have become indispensable and important tools in daily lives. In order to meet growing functional needs for mobile terminal applications, various new terminal applications are developed. A screen sharing application for the terminal is one of newly introduced terminal applications having a wide range of application prospects. One terminal can share, through the screen sharing application, contents displayed on the screen to another terminal to achieve remote sharing.

### SUMMARY

The present disclosure provides a content sharing control method, an apparatus, a storage medium, and a terminal. The method improves information security while terminals sharing the contents.

In a first aspect, the present disclosure provides a content sharing control method, including:
displaying a multitask management page, wherein the multitask management page comprises at least one application window corresponding to at least one application;
when a selection operation is performed on a first application window of the at least one application window corresponding to the at least one application, obtaining a first display content of a first application corresponding to the selected first application window; and
sharing the first display content to a share-receiving terminal.

Correspondingly, in a second aspect, the present disclosure provides a content sharing control apparatus, including:
a displaying module, configured to display a multitask management page, wherein the multitask management page comprises at least one application window corresponding to at least one application;
an obtaining module, configured to obtain a first display content of a first application corresponding to a selected first application window when a selection operation is performed on any one application window of the at least one application window corresponding to the at least one application; and
a sharing module, configured to share the first display content to a share-receiving terminal.

In a third aspect, the present disclosure provides a storage medium having a computer program stored thereon. When the computer program is loaded by a processor of an electronic device, steps in the content sharing control method as provided in the present disclosure are performed.

In a fourth aspect, the present disclosure provides an electronic device including a processor and a memory, the memory stores a computer program, the processor loads the computer program stored in the memory to perform steps in the content sharing control method provided in the present disclosure.

### BRIEF DESCRIPTION OF THE DRAWINGS

In order to more clearly illustrate technical solutions in embodiments of the present disclosure, accompanying drawings used in the embodiments will be briefly introduced below. Obviously, the accompanying drawings in the following description show only some of the embodiments of the present disclosure, and any ordinary skilled person in the art may obtain other accompanying drawings based on these drawings without creative work.

FIG. 1 is a flow chart of a content sharing control method according to an embodiment of the present disclosure.

FIG. 2 is an application scenario of the content sharing control method according to an embodiment of the present disclosure.

FIG. 3 is another application scenario of the content sharing control method according to an embodiment of the present disclosure.

FIG. 4 is another application scenario of the content sharing control method according to an embodiment of the present disclosure.

FIG. 5 is another application scenario of the content sharing control method according to an embodiment of the present disclosure.

FIG. 6 is another application scenario of the content sharing control method according to an embodiment of the present disclosure.

FIG. 7 is another application scenario of the content sharing control method according to an embodiment of the present disclosure.

FIG. 8 is a structural schematic view of a content sharing control apparatus according to an embodiment of the present disclosure.

FIG. 9 is a structural schematic view of a terminal according to an embodiment of the present disclosure.

### DETAILED DESCRIPTIONS

It should be noted that terms “first”, “second” and “third” in the present disclosure are used to distinguish different objects from each other and shall not be used to describe a particular order. Furthermore, the terms “include” and “have”, and any variations thereof, are intended to cover non-exclusive inclusion. For example, a process, a method, a system, a product, or an apparatus that includes a series of steps or modules is not limited to the listed steps or modules, but further includes steps or modules that are not listed or includes steps or modules that are inherently included in the process, the method, the system, the product, or the apparatus.

Reference to “embodiments” implies that particular features, structures, or characteristics described in an embodiment may be included in at least one embodiment of the present disclosure. Presence of the term at various sections in the specification does not necessarily refer to one same embodiment or to separate or alternative embodiments that are mutually exclusive to other embodiments. Any ordinary skilled person in the art shall understand, both explicitly and implicitly, that the embodiments described herein may be combined with other embodiments.

The present application provides a content sharing control method, an apparatus, a storage medium, and a terminal. A subject matter performing the content sharing control method may be a content sharing control apparatus provided in the embodiments of the present disclosure or an electronic device integrated with the content sharing control apparatus. The content sharing control apparatus may be configured as hardware or software. The electronic device may be a mobile terminal, and the mobile terminal may be a smart phone, a tablet computer, a vehicle-mounted terminal, or a smart wearable device, and so on.

The present disclosure provides the content sharing control method, including the following.

A multitask management page is displayed and includes an application window corresponding to at least one application.

When a selection operation is performed on any application window of the application window corresponding to the at least one application, a first display content of a first application corresponding to the selected first application window is obtained.

The first display content is shared to a share-receiving terminal.

In an embodiment, when the selection operation is performed on any application window of the application window corresponding to the at least one application, the step of obtaining the first display content of the first application corresponding to the selected first application window, includes the following.

A content sharing control widget is displayed on the multitask management page.

When a drag selection operation is performed to drag the content sharing control widget to any application window of the application window corresponding to the at least one application, the first application corresponding to the selected first application window is determined.

The first display content of the first application is obtained.

In an embodiment, when the drag selection operation is performed to drag the content sharing control widget to any application window of the application window corresponding to the at least one application, the step of determining the first application corresponding to the selected first application window, includes the following.

When a press operation is detected being performed on the content sharing control widget, obtaining a track of dragging the content sharing control widget is triggered.

When the press operation performed on the content sharing control widget is detected to be released, a track end position of the track of dragging the content sharing control widget is determined.

When the track end position is located at the first application window, an application corresponding to the first application window is determined as the first application.

In an embodiment, the content sharing control method provided by the present disclosure further includes the following.

The content sharing control widget including a first control icon is displayed at an initial position of the content sharing control widget. The first control icon is generated based on an application icon of the first application.

In an embodiment, after sharing the first display content to the share-receiving terminal, the method further includes the following.

When a drag operation that drags the content sharing control widget into the first application window again is detected, a second display content displayed on a display interface of the share-initiating terminal is obtained.

The second display content is shared to the share-receiving terminal.

In an embodiment, after sharing the second display content to the share-receiving terminal, the method further includes the following.

A control icon of the content sharing control widget is switched from the first control icon to a second control icon, and the second control icon is an initial control icon of the content sharing control widget.

In an embodiment, after sharing the first display content to the shared receiving terminal, the method further includes the following.

When a drag operation of dragging the content sharing control widget to a second application window is detected, a second application corresponding to the second application window is determined.

A third display content of the second application is obtained.

The third display content is shared to the share-receiving terminal.

In an embodiment, the content sharing control method provided by the present disclosure further includes the following.

When a touch operation performed on the content sharing control widget is detected, a plurality of control function controls are displayed, and the plurality of control function controls include a sharing ending control.

When a touch operation is performed on the sharing ending control, the first display content is stopped being shared to the share-receiving terminal.

In an embodiment, the step of sharing the first display content to the share-receiving terminal includes the following.

An account input interface of a content sharing object is displayed.

When account information is received in the account input interface, the share-receiving terminal corresponding to the account information is determined.

A content sharing request is sent to the share-receiving terminal.

When an instruction of agreeing with sharing sent from the share-receiving terminal is received, the first display content is sent to the share-receiving terminal.

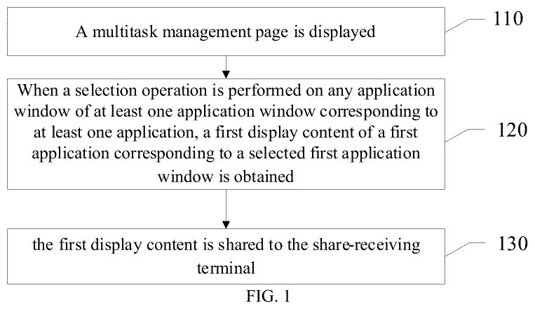

As shown in FIG. 1, FIG. 1 is a flow chart of the content sharing control method according to an embodiment of the present disclosure. As shown in FIG. 1, the content sharing control method my include following operations.

In a block 110, a multitask management page is displayed.

In the present embodiment, the content sharing method may be applied in a content sharing apparatus, and the content sharing apparatus may specifically be loaded in an intelligent terminal.

In the art, when a content displayed in a screen of one terminal is shared to another terminal via a screen sharing application, all contents displayed in the screen of a share-initiating terminal are shared a share-receiving terminal by default. However, in some cases, a user of the share-initiating terminal only wishes to share a display content in a particular application to the share-receiving terminal and does not want contents of other applications to be shared to the share-receiving terminal. In this case, the user of the share-initiating terminal cannot use other applications during screen sharing; and when an emergency situation occurs, requiring other applications to be used, information of the other applications may be leaked, affecting security of personal information.

In order to solve the above problem of sharing all contents displayed in the screen of the share-initiating terminal to the share-receiving terminal during screen sharing, which affects information security of the share-initiating terminal, the present disclosure provides the content sharing control method, which will be described in detail below.

In the present embodiment, the user may perform a trigger operation to trigger the content sharing control apparatus to enter the multitask management page, causing the content sharing apparatus to display the multitask management page. When the content sharing control apparatus is the mobile terminal, a swipe-up operation may performed on the screen to trigger displaying the multitask management page; or double-clicking may be performed on a home control to return to a home page to display the multitask management page. Alternatively, the multitask management page can be triggered to be displayed in other ways, for example, an option of displaying the multitask management page in a setting page may be selected to display the multitask management page. The multitask management page can display application windows of a plurality of applications that are running in a background or have been running for a recent period of time. The application windows may be objects that can be used to represent the plurality of applications, such as logos of the plurality of applications or thumbnail images of the plurality of applications when running during a particular period of time. When the number of the plurality of applications is large, the multitask management page may display application windows of a part of the plurality of applications, and the user may slide the page to switch displaying application windows of another part of the plurality of applications.

In some embodiments, before displaying the multitask management page in response to the trigger operation to enter the multitask management page, the method may further include the following.

1. When an instruction of initiating screen sharing is received, an account input interface of a screen sharing object is displayed.

2. When account information is received, a screen sharing request is sent to a client side corresponding to the account information.

3. When an instruction of agreeing with screen sharing is received, the display content on the screen is shared to the terminal corresponding to the screen sharing object.

In the present embodiment, a screen sharing application may be accessed firstly, a screen sharing task may be initiated. Subsequently, the multitask management page is triggered to be displayed in the screen sharing task, a specific application in the multitask management page is selected, a screen sharing range is locked to the selected specific application.

In the block 120, when a selection operation is performed on any application window of at least one application window corresponding to at least one application, a first display content of a first application corresponding to a selected first application window is obtained.

After the content sharing control apparatus enters the multitask management page and the application windows of the plurality of applications are displayed in the multitask management page. The user may select any one application window in the multitask management page in order to set a content of an application corresponding to the selected application window as a to-be-shared content. Herein, in order to differentiate the selected application window from other application windows, the application window selected by the user herein is noted as the first application window, the application corresponding to the first application window is the first application, and the content corresponding to the first application is the first display content. The first display content may be a static image or a dynamic video. For example, when the first application is a video playing application, and when the first application is switched to running at the background, video playing is automatically paused. When the first application is switched to running at the background, the display content shared to the share-receiving terminal is a static image at the time point when the video playing is paused. When the first application is a live broadcast application, and when the first application is switched to running at the background, live broadcast continues. When the first application is switched running at the background, the display content shared to the share-receiving terminal may be a dynamic video content.

In some embodiments, obtaining the first display content of the first application corresponding to the selected first application window when the selection operation is performed on any one application window of the application windows of the plurality of applications, includes the following.

1. A content sharing control widget is displayed on the multitask management page.

2. When a drag selection operation of dragging the content sharing control widget to any one application window of the application windows of the plurality of applications is performed, the first application corresponding to the selected first application window is determined.

3. The first display content of the first application is obtained.

In the present embodiment, the shared application can be selected and locked by dragging the control to the application window corresponding to the application. Specifically, the content sharing control widget may be displayed in the multitask management page. When the drag selection operation of dragging the content sharing control widget to any one application window of the application windows of the plurality of applications is performed, the first application corresponding to the selected first application window is determined, and the first display content of the first application is obtained and is shared to the share-receiving terminal. The content sharing control widget may be a hover ball. The hover ball may be suspended above all applications and fixed at a fixed position on the display screen of the content sharing control apparatus.

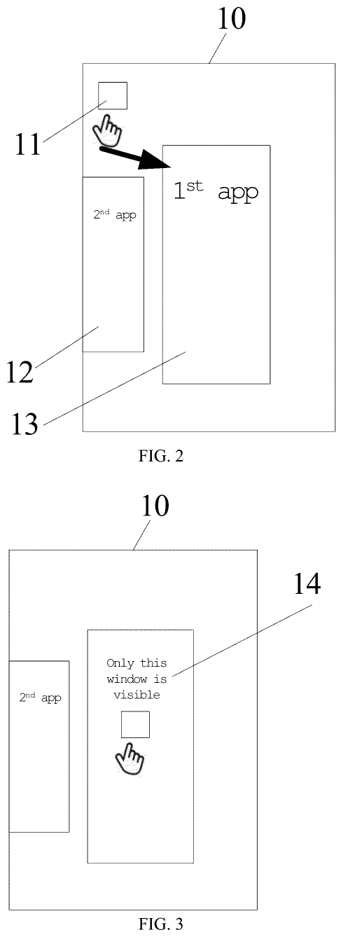

Specifically, as shown in FIG. 2, an application scenario of the content sharing control method according to an embodiment of the present disclosure is shown. As shown in FIG. 2, the multitask management page 10 is displayed. The first application window 13 corresponding to the first application and a second application window 12 corresponding to a second application are displayed in the multitask management page 10. In addition, the content sharing control widget 11 is displayed in the multitask management page. The user can drag the content sharing control widget 11 in the multitask display page 10 to the first application window 13 or the second application window 12 to set the shared content to the application corresponding to the application window. For example, when the user drags the content sharing control widget 11 to the first application window 13, the shared content is locked to the first application, and the first display content of the first application can be obtained and shared to the share-receiving terminal. After locking the content shared to the share-receiving terminal to one application, the share-receiving terminal can only view the display content corresponding to the locked application and cannot view display contents corresponding to other applications.

When the user drags the content sharing control widget 11 to the first application window 13, a reminder message “share images of the application only” or “release finger to lock to share images of the application, move away finger to cancel sharing” may be triggered. After locking the shared content to the first application, a logo of the first application may be used to update a display image of the content sharing control widget. In this way, it is recognized whether content sharing is currently locked to one application, so as to facilitate identifying the locked one application. Specifically, as shown in FIG. 3, another scenario of the content sharing control method according to an embodiment is shown. As shown in FIG. 3, when the user drags the content sharing control widget to the first application window, the reminder message 14 is displayed in the first application window. The reminder message may the above-mentioned “share images of the application only”. As shown in FIG. 4, another scenario of the content sharing control method according to an embodiment is shown. As shown in FIG. 4, when the user drags the content sharing control widget to the first application window, an operation guide 15 is displayed, and the operation guide 15 may be the above-mentioned “release finger to lock to share images of the application, move away finger to cancel sharing”.

In some embodiments, the application windows of the plurality of applications in the multitask management page have different display priorities. An application that is currently being used is at a first display priority. When the user drags the content sharing control widget to the application window of the first application in the multitask management page, a display priority of the first application may be set to the first display priority.

In some embodiments, determining the first application corresponding to the selected first application window when the drag selection operation of dragging the content sharing control widget to any one application window of the application windows of the plurality of applications is performed, includes the following.

2.1 When a press operation performed on the content sharing control widget is detected, obtaining a dragging track of the content sharing control widget is triggered.

2.2 When the press operation on the content sharing control widget is detected to be released, a track end position of the dragging track is determined.

2.3 When the track end position is in the first application window, the application corresponding to the first application window is determined as the first application.

In the present embodiment, specific identification of the drag selection operation may be achieved by gesture determination of the content sharing control widget. Specifically, a press gesture detection may be performed on the content sharing control widget firstly. When the press gesture performed on the content sharing control widget is detected, a position detection of the content sharing control widget is triggered to determine whether a position of the content sharing control widget is moved. When the position of the sharing control widget is detected as being moved, it is determined that the sharing control widget is dragged, and the track of the sharing control widget is obtained continuously in real time. Subsequently, a press releasing gesture can be further recognized on the content sharing control widget. When the press releasing gesture is detected, the track end position of the dragging track is determined. When the track end position is in the application window corresponding to one application, it is determined that the one application is locked as the application for sharing.

In some embodiments, when the press releasing gesture is detected, it is further detected whether an instantaneous fast change occurs in the dragging track of the content sharing control widget at the time point when the press releasing gesture is detected. The instantaneous fast change corresponds to a fast stroking gesture performed by the user. When the instantaneous fast change occurs, it is determined that locking of the application for sharing is canceled. When no instantaneous fast change is detected, the application corresponding to the track end point is locked as the application for sharing, and only the display content corresponding to the application is shared to the share-receiving terminal.

In some embodiments, the content sharing control method in the present disclosure may further include the following.

The content sharing control widget having a first control icon is displayed at an initial position of the content sharing control widget. The first control icon is generated based on an application icon of the first application.

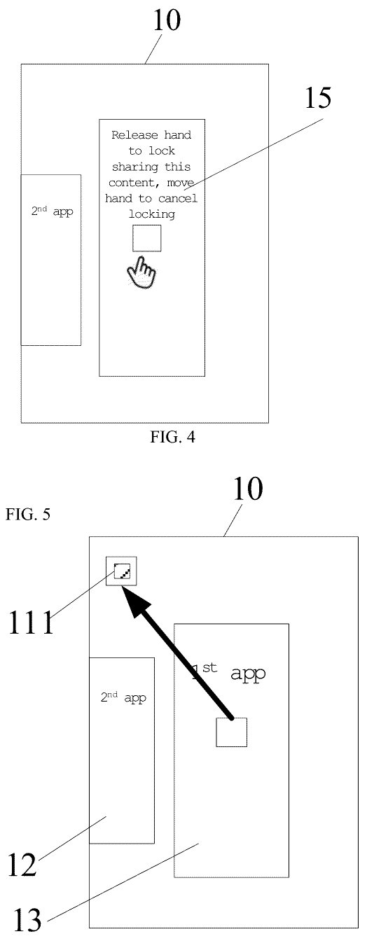

That is, in the present embodiment, when the application for screen sharing is locked to the first application, the icon displayed on the content sharing control widget is changed accordingly, and specifically, the icon displayed on the content sharing control widget may be the application icon of the first application, so as to remind the user that the current screen sharing is locked to sharing the first application. Specifically, as shown in FIG. 5, when the user drags the content sharing control widget to the first application window and releases (i.e., un-presses) the control, the content sharing control widget is reset (moving back) to the initial position, and the application icon 111 of the first application is displayed in the content sharing control widget.

In some embodiments, the user may drag the content sharing control widget to the first application window corresponding to the first application and pause dragging without releasing the press on the content sharing control widget during pausing. After the pausing reaches a preset time length, the user may continue dragging the content sharing control widget to the second application window and then release the press on the content sharing control widget. In this way, the content shared to the share-receiving terminal can be locked to the first application and the second application, allowing contents of a plurality of applications to be locked for sharing. In the present embodiment, when the first application is displayed on a front page of a display interface of the content sharing control apparatus, the display content of the first application is shared to be displayed at the share-receiving terminal. When the second application is displayed on the front page of the display interface of the content sharing control apparatus, the display content of the second application is shared to be displayed at the share-receiving terminal. When neither the first application nor the second application is displayed in the display interface of the content sharing control apparatus, but a display content of a third application which is not locked for sharing is displayed in the display interface of the content sharing control apparatus, display priorities of the first application and the second application are obtained, and the display content corresponding to one of the first application and the second application having a higher display priority is displayed in the display interface of the share-receiving terminal.

In a block 130, the first display content is shared to the share-receiving terminal.

When it is determined that the content sharing is locked to the selected first application, the first display content displayed by the first application is obtained and is shared to the share-receiving terminal. That is, by performing the content sharing control method of the present disclosure, the screen sharing may be locked to one application by selecting a target task in the multitask management page, such that information leakage caused by full-screen sharing is avoided, and information security is ensured. That is, according to the content sharing control method provided by the present disclosure, a scope of the shared content during the screen sharing can be proactively adjusted. For example, the display content of only one application is set to be shared and visible in the screen of another terminal, preventing information of other applications from being leaked. It is understood that when one application is locked as the application corresponding to the shared content, all contents of other applications are not shared to the share-receiving terminal. Contents of other applications herein include, but not limited to, incoming call alerts, message alerts, and information pop-up windows.

In some embodiments, after sharing the first display content to the share-receiving terminal, the method further includes the following.

1. When another drag operation that drags the content sharing control widget into the first application window again is detected, a second display content displayed on the display interface of the share-initiating terminal is obtained.

2. The second display content is shared to the share-receiving terminal.

In the present embodiment, when the content sharing control widget is dragged to the first application window, content sharing is locked to the first application corresponding to the first application window. When the user releases the press operation on the content sharing control widget, the content sharing control widget is then automatically reset to the initial position thereof.

In a case of the application for sharing being locked, the user may again drag the content sharing control widget that is reset to the initial position to the application window corresponding to the locked application, such that the locked application is unlocked. After unlocking, the display content corresponding to the locked application is not the only content shared to the share-receiving terminal, but all contents displayed on the display screen of the share-initiating terminal, i.e., the content sharing control apparatus of the present embodiment, are shared to the share-receiving terminal to be displayed. When the application for sharing is locked to one target application, and when the user enters the multitask management page again, prompting information is displayed above the target application, such as “Currently, only the window of this application is shared” or “The other terminal can only view the window of this application”, and so on. The prompting information is configured to prompt a current screen sharing state to the user. When locking of the target application for sharing is released and the multitask management page is accessed again, the prompt information is no longer displayed above the application window of the target application.

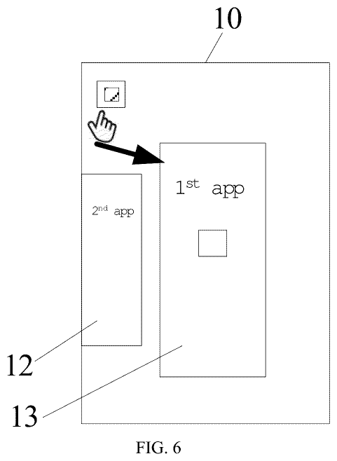

As shown in FIG. 6, another application scenario of the content sharing control method according to the present disclosure is shown, as shown in FIG. 6, when the user drags the content sharing control widget displaying the application icon 111 of the first application to the first application window 13 again, the screen sharing being locked to the first application is canceled, and all contents displayed on the display screen of the share-initiating terminal are shared to the share-receiving terminal.

That is, when the another drag operation of dragging the content sharing control widget into the first application window again is performed, the second display content displayed on the display interface of the share-initiating terminal is obtained, and the second display content is shared to the share-receiving terminal.

In some embodiments, when the user drags the content sharing control widget to the first application window of the locked first application again, a relevant prompting text may be displayed, for example, “displaying the shared screen is canceled” or relevant operation guide may be displayed, such as “release the hand to cancel locking, remove the hand to cancel unlocking the screen”, and so on. Further, since a pattern displayed in the content sharing control widget is switched to the logo of the locked application when the shared content is locked to one application, the pattern displayed in the content sharing control widget is further switched to a default pattern after the locking of the application for sharing is canceled.

In some embodiments, after sharing the first display content to the share-receiving terminal, the method further includes the following.

A. When the another drag operation of dragging the content sharing control widget into the second application window is performed, the second application corresponding to the second application window is determined.

B. The third display content of the second application is obtained.

C. The third display content is shared to the share-receiving terminal.

In the present embodiment, the application that is locked for sharing can be switched by dragging the content sharing control widget to the application window corresponding to another application in the multitask management page. For example, when it is the content of the first application that is locked to be shared to the share-receiving terminal, the content sharing control widget can be dragged to the second application window in the multitask management page, where the second application window is the application window corresponding to the second application, such that the content that is locked to be shared to the share-receiving terminal is switched from the content of the first application to the content of the second application. In this case, the display content of the second application is obtained and is specifically the third display content, and the third display content is shared to the share-receiving terminal.

In some embodiments, the content sharing control method according to the present disclosure may further include the following.

a. When a touch operation on the content sharing control widget is performed, a plurality of control widgets are displayed, and the plurality of control widgets include a sharing ending widget.

b. When the touch operation is performed on the sharing ending widget, the first display content is stopped being sent to the share-receiving terminal.

In an embodiment, the content sharing control widget in the present disclosure include other functions in addition to a function of locking the application for sharing by dragging the content sharing control widget. The other functions include, but not limited to, the function of ending the screen sharing.

Specifically, the user may click on the content sharing control widget to trigger displaying the plurality of control widgets, and the plurality of control widgets may include: the sharing ending widget, an authorization widget for authorizing the other party to operate the terminal, and a voice setting widget. The user may end the screen sharing by clicking on the sharing ending widget of the displayed plurality of control widgets.

In some embodiments, sharing the first display content to the share-receiving terminal includes the following.

An account input interface of a content sharing object is displayed.

When account information is received at the account input interface, the share-receiving terminal corresponding to the account information is determined.

The content sharing request is sent to the share-receiving terminal.

When the instruction of agreeing with the screen sharing sent from the share-receiving terminal is received, the first display content is sent to the share-receiving terminal.

In the above embodiment, the application that is locked for content sharing is locked during the screen sharing process, and that is, the content sharing control apparatus firstly initiates the screen sharing request to the share-receiving terminal, the share-receiving terminal receives the screen sharing request and starts to receive the display content shared by and sent from the content sharing control apparatus. The share-receiving terminal further displays the shared content in the display interface of the share-receiving terminal. Subsequently, when the content sharing control apparatus locks the shared content to one application, the display content received in the share-receiving terminal is also locked to the one application. In the present embodiment, the share-receiving terminal may detect a sharing control behavior performed at the share-initiating terminal, and that is, a sharing control operation performed at the terminal where the content sharing control apparatus is configured, and that is, a behavior of locking the shared content to one application. In this way, a poor content sharing experience may be caused.

Therefore, in the present embodiment, the application for sharing is locked firstly, and subsequently, the screen sharing request is initiated to the share-receiving terminal. After receiving the instruction of agreeing with the screen sharing sent from the share-receiving terminal, the display content corresponding to the locked application can be shared directly to the share-receiving terminal. In this process, the share-receiving terminal does not perceive a process of locking one application, the screen sharing experience at the share-receiving terminal is improved.

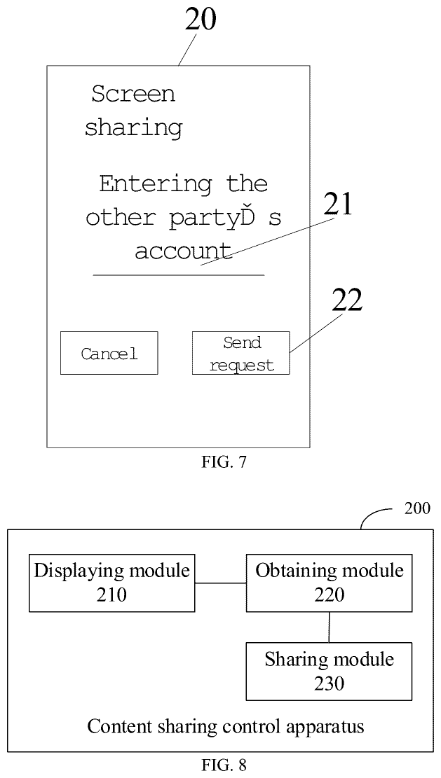

Specifically, as shown in FIG. 7, another application scenario of the content sharing control according to the present disclosure is shown. As shown in FIG. 7, when the user drags the content sharing control widget to the application window corresponding to one application, the account input interface 20 of the content sharing object is triggered to be displayed. The account input interface 20 includes an account input region 21 and a request sending widget 22. The user can input the account information of the content sharing object in the account input region 21, the account information may be mobile phone number information or account information registered by the user in the screen sharing application. After entering the account information, the user may further click the request sending widget 22 to send the screen sharing request to the terminal corresponding to the account. After receiving the instruction of agreeing with the screen sharing returned from the content sharing object, the screen sharing task can be constructed with the content sharing object. In the screen sharing task, the content sharing control apparatus shares only the first display content corresponding to the first application to the content sharing object.

According to the above description, in the content sharing control method of the present disclosure, the multitask management page is displayed, the multitask management page includes the at least one application window of the at least one application. When the selection operation performed on any one application window of the at least one application window of the at least one application is detected, the first display content of the first application corresponding to the selected first application window is obtained. The first display content is shared to the share-receiving terminal. According to the method, the shared content can be locked within the target application by selecting the target application in the multitask management page, such that contents of the other applications can be avoided from being shared to the share-receiving terminal, information security during the content sharing can be improved. Moreover, the content sharing control method in the present disclosure is screen sharing control in the perspective of applications, and therefore, the method is more in line with a habit of using the terminal. Moreover, the user can adjust the contents of the application window visible in the screen of the share-receiving terminal during the screen sharing process, greatly improving flexibility of screen sharing.

As shown in FIG. 8, a schematic structural view of a content sharing control apparatus 200 is shown. The content sharing control apparatus 200 is applied to the electronic device provided in the present disclosure. As shown in FIG. 8, the content sharing control apparatus 200 may include following components.

A displaying module 210 is configured to display the multitask management page, and the multitask management page includes at least one application window corresponding to at least one application.

An obtaining module 220 is configured to obtain the first display content of the first application corresponding to the selected first application window when the selection operation performed on any one application window of the at least one application window corresponding to the at least one application is detected.

A sharing module 230 is configured to share the first display content to the share-receiving terminal.

In some embodiments, the obtaining module includes following components.

A first displaying submodule is configured to display the content sharing control widget in the multitask management page.

A first determination submodule is configured to determine the first application corresponding to the selected first application window when the drag selection operation of dragging the content sharing control widget to any one application window of the at least one application window corresponding to the at least one application is performed.

A first obtaining submodule is configured to obtain the first display content of the first application.

In some embodiments, the first determination submodule includes following components.

A triggering unit is configured to trigger obtaining the drag track of the content sharing control widget when the press operation on the content sharing control widget is detected.

A first determination unit is configured to determine a track end position of the drag track when the press operation on the content sharing control widget is detected as being released.

A second determination unit is configured to determine the application corresponding to the first application window as the first application when the track end position is located in the first application window.

In some embodiments, the content sharing control apparatus in the present embodiment further includes following operations.

A second display submodule is configured to display the content sharing control widget including the first control icon at the initial position of the content sharing control widget. The first control icon is generated according to the application icon of the first application.

In some embodiments, the content sharing control apparatus in the present embodiment further includes following components.

A second obtaining submodule is configured to obtain the second display content displayed on the display interface of the share-initiating terminal when the drag operation of dragging the content sharing control widget to the first application window is performed.

A first sharing submodule is configured to share the second display content to the share-receiving terminal.

In some embodiments, the content sharing control apparatus of the present disclosure further includes the following.

A switching submodule is configured to switch the control icon of the content sharing control widget from the first control icon to the second control icon, and the second control icon is the initial control icon of the content sharing control widget.

In some embodiments, the content sharing control apparatus of the present disclosure further includes following components.

A second determination submodule is configured to determine the second application corresponding to the second application window when the drag operation of dragging the content sharing control widget to the second application window is performed.

A third determination submodule is configured to obtain the third display content of the second application.

A second sharing submodule is configured to share the third display content to the share-receiving terminal.

In some embodiments, the content sharing control apparatus in the present disclosure further includes the following components.

A third display submodule is configured to display the plurality of control widgets when the touch operation on the content sharing control widget is performed, and the plurality of control widgets include the sharing ending widget.

A control submodule configured to stop sending the first display content to the share-receiving terminal when the touch operation is performed on the sharing ending widget.

In some embodiments, sharing module includes following components.

A fourth display submodule is configured to display the account input interface of the content sharing object.

A fourth determination submodule is configured to determine the share-receiving terminal corresponding to the account information when the account information is received at the account input interface.

A first sending submodule is configured to send the content sharing request to the share-receiving terminal.

A second sending submodule is configured to send the first display content to the share-receiving terminal when the instruction of agreeing with content sharing returned from the share-receiving terminal is received.

It should be noted that the content sharing control apparatus 200 in the present embodiment and the content sharing control method shown in FIG. 1 in the above embodiment belong to a same concept. A detailed implementation process is described in the above related embodiments and will not be repeated herein.

According to the above description, for the content sharing control device apparatus in the present disclosure, the multitask management page is displayed through the displaying module 210. The multitask management page includes the at least one application window corresponding to the at least one application. When the selection operation is performed on any one application window of the at least one application window of the at least one application, the obtaining module 220 obtains the first display content of the first application corresponding to the selected first application window. The sharing module 230 shares the first display content to the share-receiving terminal. According to the above method, the shared content can be locked in the target application by selecting the target application on the multitask management page. In this way, the content of other applications is prevented from being shared to the share-receiving terminal, information security during content sharing is improved.

The present disclosure further provides a storage medium on which a computer program is stored. When the computer program stored therein is executed on a processor of the electronic device in the present embodiment, the processor of the electronic device is caused to execute any blocks in the content sharing control method. The storage medium may be a magnetic disk, an optical disk, a read only memory (ROM) or a random access memory (RAM), and so on.

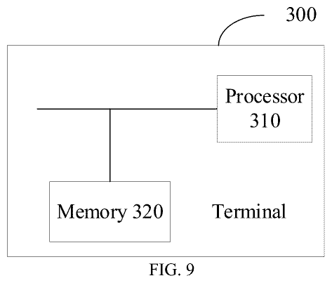

The present disclosure further provides a terminal. As shown in FIG. 9, the terminal 300 includes a processor 310 and a memory 320.

The processor 310 in the present embodiment may be a general-purpose processor, such as an ARM architecture processor. The computer program is stored in the memory 320, the memory 320 may be a high-speed random access memory or a non-volatile memory, such as at least one disk storage device, a flash memory device, or other volatile solid-state storage devices. Accordingly, the memory 320 may further include a memory controller to provide the processor 301 with access to the memory 320. The processor 310 is configured to execute the computer program in the memory 320 to perform the content sharing control method in any of the above embodiments.

For example, the method includes: displaying the multitask management page, which includes the at least one application window corresponding to the at least one application; obtaining the application corresponding to the selected first application window when the selection operation is performed on any one application window of the at least one application window corresponding to the at least one application; and sharing the first display content to the share-receiving terminal.

The content sharing control method, the apparatus, the storage medium and the terminal provided in the present disclosure are described in detail in the above. Specific examples are described to illustrate principles and implementation methods of the present disclosure. Description of the above embodiments is only for understanding core ideas of the present disclosure. At the same time, any ordinary skilled person in the art may perform changes in specific implementation and the application scope based on the ideas of the present disclosure. In summary, the content of the present specification does not limit the present disclosure.

What is claimed is:

1. A content sharing control method, comprising:
displaying a multitask management page, wherein the multitask management page comprises at least one application window corresponding to at least one application;
when a selection operation is performed on a first application window of the at least one application window corresponding to the at least one application, obtaining a first display content of a first application corresponding to the selected first application window;
sharing the first display content to a share-receiving terminal.

2. The content sharing control method according to claim 1, wherein, when the selection operation is performed on the first application window of the at least one application window corresponding to the at least one application, the obtaining a first display content of a first application corresponding to the selected first application window, comprises:
displaying a content sharing control widget on the multitask management page;
when a drag selection operation of dragging the content sharing control widget to the first application window of the at least one application window corresponding to the at least one application is performed, determining the first application corresponding to the selected first application window; and
obtaining the first display content of the first application.

3. The content sharing control method according to claim 2, wherein, when a drag selection operation of dragging the content sharing control widget to the first application window of the at least one application window corresponding to the at least one application is performed, the determining the first application corresponding to the selected first application window, comprises:
when a press operation on the content sharing control widget is detected, triggering obtaining a drag track of the content sharing control widget;
when the press operation on the content sharing widget is detected as being released, determining a track end position of the drag track; and
when the track end point is located in the first application window, determining an application of the at least one application corresponding to the first application window as the first application.

4. The content sharing control method according to claim 3, further comprising:
displaying the content sharing control widget comprising a first control icon at an initial position of the content sharing control widget, wherein the first control icon is generated according to an application icon of the first application.

5. The content sharing control method according to claim 4, wherein after the sharing the first display content to a share-receiving terminal, the method further comprises:
when another drag operation of dragging the content sharing control widget to the first application window again is performed, obtaining a second display content displayed on a display interface of a share-initiating terminal; and
sharing the second display content to the share-receiving terminal.

6. The content sharing control method according to claim 5, wherein after the sharing the second display content to the share-receiving terminal, the method further comprises:
switching the control icon of the content sharing control widget from the first control icon to a second control icon, wherein the second control icon is an initial control icon of the content sharing control widget.

7. The content sharing control method according to claim 2, wherein after the sharing the first display content to a share-receiving terminal, the method further comprises:
when a drag operation of dragging the content sharing control widget into a second application window, determining a second application corresponding to the second application window;
obtaining a third display content of the second application; and
sharing the third display content to the share-receiving terminal.

8. The content sharing control method according to claim 2, further comprising:
when a touch operation on the content sharing control widget is performed, displaying a plurality of control widgets, where the plurality of control widgets comprise a sharing ending widget;
when the touch operation on the sharing ending widget is performed, stopping sending the first display content to the share-receiving terminal.

9. The content sharing control method according to claim 1, wherein the sharing the first display content to a share-receiving terminal comprises:
displaying an account input interface of a content sharing object;
when account information is received at the account input interface, determining the share-receiving terminal corresponding to the account information;
sending a content sharing request to the share-receiving terminal;
when an instruction of agreeing with content sharing returned from the share-receiving terminal is received, sending the first display content to the share-receiving terminal.

10. A storage medium, having a computer program stored thereon, wherein the computer program, when being loaded by a processor of an electronic device, is configured to perform:
displaying a multitask management page, wherein the multitask management page comprises at least one application window corresponding to at least one application;
when a selection operation is performed on a first application window of the at least one application window corresponding to the at least one application, obtaining a first display content of a first application corresponding to the selected first application window;
sharing the first display content to a share-receiving terminal.

11. The storage medium according to claim 10, wherein, when the selection operation is performed on the first application window of the at least one application window corresponding to the at least one application, obtaining the first display content of a first application corresponding to the selected first application window, the computer program is configured to perform:
displaying a content sharing control widget on the multitask management page;
when a drag selection operation of dragging the content sharing control widget to the first application window of the at least one application window corresponding to the at least one application is performed, determining the first application corresponding to the selected first application window; and
obtaining the first display content of the first application.

12. A terminal, comprising a processor and a memory, wherein the memory stores a computer program, the processor is configured to load the computer program to perform:
displaying a multitask management page, wherein the multitask management page comprises at least one application window corresponding to at least one application;
when a selection operation is performed on a first application window of the at least one application window corresponding to the at least one application, obtaining a first display content of a first application corresponding to the selected first application window;
sharing the first display content to a share-receiving terminal.

13. The terminal according to claim 12, wherein, when the selection operation is performed on any one application window of the at least one application window corresponding to the at least one application, obtaining the first display content of the first application corresponding to the selected first application window, the processor is configured to load the computer program to perform:
displaying a content sharing control widget on the multitask management page;
when a drag selection operation of dragging the content sharing control widget to any one application window of the at least one application window corresponding to the at least one application is performed, determining the first application corresponding to the selected first application window; and
obtaining the first display content of the first application.

14. The terminal according to claim 13, wherein when a drag selection operation of dragging the content sharing control widget to any one application window of the at least one application window corresponding to the at least one application is performed, determining the first application corresponding to the selected first application window, the processor is configured to load the computer program to perform:
when a press operation on the content sharing control widget is detected, triggering obtaining a drag track of the content sharing control widget;
when the press operation on the content sharing widget is detected as being released, determining a track end position of the drag track; and
when the track end point is located in the first application window, determining an application of the at least one application corresponding to the first application window as the first application.

15. The terminal according to claim 14, wherein the processor is configured to load the computer program to perform:
displaying the content sharing control widget comprising a first control icon at an initial position of the content sharing control widget, wherein the first control icon is generated according to an application icon of the first application.

16. The terminal according to claim 15, wherein after the sharing the first display content to a share-receiving terminal, the processor is configured to load the computer program to perform:
when another drag operation of dragging the content sharing control widget to the first application window again is performed, obtaining a second display content displayed on a display interface of a share-initiating terminal; and
sharing the second display content to the share-receiving terminal.

17. The terminal according to claim 16, wherein after the sharing the second display content to the share-receiving terminal, the processor is configured to load the computer program to perform:
switching the control icon of the content sharing control widget from the first control icon to a second control icon, wherein the second control icon is an initial control icon of the content sharing control widget.

18. The terminal according to claim 13, wherein after the sharing the first display content to a share-receiving terminal, the processor is configured to load the computer program to perform:
when a drag operation of dragging the content sharing control widget into a second application window, determining a second application corresponding to the second application window;
obtaining a third display content of the second application; and
sharing the third display content to the share-receiving terminal.

19. The terminal according to claim 13, wherein the processor is configured to load the computer program to perform:
when a touch operation on the content sharing control widget is performed, displaying a plurality of control widgets, where the plurality of control widgets comprise a sharing ending widget;
when the touch operation on the sharing ending widget is performed, stopping sending the first display content to the share-receiving terminal.

20. The terminal according to claim 12, wherein when sharing the first display content to the share-receiving terminal, the processor is configured to load the computer program to perform:
displaying an account input interface of a content sharing object;
when account information is received at the account input interface, determining the share-receiving terminal corresponding to the account information;
sending a content sharing request to the share-receiving terminal;
when an instruction of agreeing with content sharing returned from the share-receiving terminal is received, sending the first display content to the share-receiving terminal.
